(19) United States
(12) Patent Application Publication
(10) Pub. No.: US 2016/0372991 A1
(43) Pub. Date: Dec. 22, 2016

(54) ENERGY TRANSMISSION DEVICE

(71) Applicant: AUDI AG, Ingolstadt (DE)

(72) Inventors: Kai Brune, Hepberg (DE); Max Possen, Lenting (DE); Andre Brune, Hannover (DE); Jörn Steinbrink, Hannover (DE); Jan-Niklas Weber, Laatzen (DE); Carsten Selke, Wunstorf (DE); Bernd Ponick, Hannover (DE)

(73) Assignee: AUDI AG, Ingolstadt (DE)

(21) Appl. No.: 15/183,295

(22) Filed: Jun. 15, 2016

(30) Foreign Application Priority Data
Jun. 16, 2015 (DE) 10 2015 007 586.1

(51) Int. Cl. H02K 11/33; H02J 50/10; H01F 38/14

(52) U.S. Cl. CPC H02K 11/33; H01F 38/14; H02J 50/10

(57) ABSTRACT

An energy transmission device for contactless transmission of electric energy includes a primary coil device and a secondary coil device, the secondary coil device being supported for rotation relative to the primary coil device about a rotation axis. The primary coil device has a primary yoke element, multiple primary leg elements and a primary winding, the secondary coil device having a secondary yoke element, multiple secondary leg elements and a secondary winding, said primary yoke element and/or the secondary yoke element being made of a laminated core. When viewed in longitudinal section of the rotation axis, the primary yoke element rests against at least one of the primary leg elements and/or the secondary yoke element rests against at least one of the secondary leg elements along a respective joint edge, said respective joint edge and/or a longitudinal center axis of the respective joint edge being slanted relative to the rotation axis.

### CROSS-REFERENCES TO RELATED APPLICATIONS

This application claims the priority of German Patent Application, Serial No. 10 2015 007 586.1, filed Jun. 16, 2015, pursuant to 35 U.S.C. 119(a)-(d), the content of which is incorporated herein by reference in its entirety as if fully set forth herein.

### BACKGROUND OF THE INVENTION

The present invention relates to an energy transmission device for contactless transmission of electric energy.

The following discussion of related art is provided to assist the reader in understanding the advantages of the invention, and is not to be construed as an admission that this related art is prior art to this invention.

An electric machine serves for example for providing a torque or for converting mechanical energy into electric energy. For this purpose the electric machine has a stator and a rotor, which is supported for rotation relative to the stator. Depending on the type of electric machine it may be necessary to provide electric energy to the rotor. This is for example the case when the electric machine is configured as electrically excited synchronous machine. However, other configurations of the electric machine can also be realized. For transmitting energy the energy transmission device is provided. The energy transmission device has for example at least one slip ring and a brush that is in contact with the slip ring. The slip ring is hereby preferably arranged on the rotor while the brush is assigned to the stator. Usually multiple slip rings and corresponding brushes are provided.

The slip ring and the brush are configured so that also during rotation of the rotor relative to the stator a sliding contact is permanently or at least substantially permanently established between the slip ring and the brush so that electric energy can be transmitted. Such a conductive energy transmission device however requires extensive maintenance. In addition it is sensitive to contaminations and changes in humidity, which may result in unreliable transmission of the electric energy.

For this reason it is advantageous to configure the energy transmission device contactless in order to be able to transmit electric energy without contact between the stator and the rotor. For this purpose a primary coil device and a secondary coil device are provided. The primary coil device can also be referred to as primary active part and the secondary coil device as secondary active part. The primary coil device is adventurously assigned to the stator of the electric machine and is stationary relative to the stator. The secondary coil device on the other hand is adventurously assigned to the rotor of the electric machine and is stationary relative to the rotor. In case of a rotary movement of the rotor relative to the stator thus a corresponding rotation of the secondary coil device relative to the primary coil device occurs. However the energy transmission device can also be used in other areas, i.e., independent of the electric machine.

It would be desirable and advantageous to provide a contactless energy transmission device which can be produced easily and also has a high mechanical load capability.

### SUMMARY OF THE INVENTION

According to one aspect of the present invention An energy transmission device for contactless transmission of electric energy, includes a primary coil device and a secondary coil device, wherein the secondary coil device is supported for rotation relative to the primary coil device about a rotation axis, the primary coil device having a primary yoke element, multiple primary leg elements and a primary winding, the secondary coil device having a secondary yoke element, multiple secondary leg elements and a secondary winding, wherein the primary yoke element and/or the secondary yoke element is made of a laminated core, wherein, when viewed in longitudinal section relative to the rotation axis, the primary yoke element rests against at least one of the primary leg elements and/or the secondary yoke element rests against at least one of the secondary leg elements along a respective joint edge, and wherein the respective joint edge and/or a longitudinal center axis of the respective joint edge is slanted relative to the rotation axis.

The primary coil device has the primary yoke element, the primary leg elements and the primary winding. The secondary coil device is essentially built analogously and correspondingly has the secondary yoke element, the secondary leg elements and the secondary winding. The primary coil device and the secondary coil device are arranged so that when an AC current is applied on the primary coil device a corresponding AC voltage is induced in the secondary coil device. The yoke elements, i.e., the primary yoke element and the secondary yoke element and the leg elements serve for increasing the efficiency of energy transmission between the primary coil device and the secondary coil device.

Preferably the primary leg elements are provided on both sides of the primary yoke element so that a respective primary leg elements is arranged on opposing end faces of the primary yoke element. When viewed in longitudinal section of the rotation axis, the primary yoke element and the primary leg element can hereby be substantially U-shaped relative to each other, wherein the primary leg elements are connected with each other via the primary yoke element. Preferably the primary leg elements are fastened to each other exclusively via the primary yoke element and are otherwise spaced apart from each other or separate from each other.

Between the primary leg elements the primary winding is arranged, wherein the primary winding extends about the primary yoke element, i.e., the primary winding completely engages about the primary yoke element relative to the rotation axis. In particular the primary coil device has a plurality of windings, wherein each winding of the primary coil device completely engages about the primary yoke element in circumferential direction. The secondary coil device is generally constructed analogously to the primary coil device so that the reference is made to the description above.

When viewed in longitudinal section each of the primary leg elements has a free end that faces away from the primary yoke element. Also each secondary leg element has such a free end, which is located on the side of the respective secondary leg element, which faces away from the secondary yoke element. The primary coil device and the secondary coil device are arranged relative to each other so that the free ends of the primary leg elements and the secondary yoke elements protrude toward each other. In particular the free ends of the primary leg elements are aligned with the free ends of the secondary leg elements. Particularly preferably the arrangement of primary yoke element and secondary leg elements has the same dimensions in axial direction as the arrangement of the secondary yoke element and the secondary leg elements. In such an embodiment these arrangements are situated in axial direction preferably at the same position.

The primary yoke element, the secondary yoke element or both are made of the laminated core or a respective laminated core. The term laminated core means an arrangement of multiple laminations or sheet metal lamellas which are fastened to each other, for example baked to each other. The laminations can be electrically insulated from each other. In this way eddy currents in the primary yoke element or the secondary yoke element can be at least partially avoided. The primary yoke element or the secondary yoke element represents an iron core of the primary coil device or the secondary coil device or at least a part of this iron core. The laminations may be made of electrical sheets. Constructing the primary yoke element and/or the secondary yoke element as laminated core achieves an excellent durability of the energy transmission device and/or the electric machine.

In order to optimize the flux guidance of the magnetic flux in the primary coil device or the secondary coil device, the slanted joint edge is provided. The joint edge is located between the primary yoke element and the at least one of the primary leg elements on one hand and/or between the secondary yoke element and the at least one of the secondary leg elements on the other hand. This means that the primary yoke element rests against the primary leg element along the joint edge or the secondary yoke element rests against the secondary leg element along the joint edge. The primary yoke element is thus not configured one-piece with the primary leg elements and/or the secondary yoke element is not configured one-piece with the secondary leg elements. Rather they are first present as separate elements that are to be fastened to each other.

Generally speaking, a respective joint edge is present between the primary yoke element and each of the primary leg elements and between the secondary yoke element and each of the secondary leg elements. At least one of these joint edges, preferably multiple of the joint edges, in particular however all joint edges, are slanted relative to the rotation axis. This means that the joint edges and/or their longitudinal center axis or an imagined extension of the joint edge or the longitudinal center axis encloses an angle with the rotation axis which is greater than 0° and smaller than 90°. Particularly advantageous is an angle between 30° and 60°, between 35° and 55°, between 40° and 50°, or of exactly 45°.

When viewed in longitudinal section the longitudinal center axis of the joint edge is a straight line between a radially innermost contact point at which the primary yoke element rests against the corresponding primary leg element or the secondary yoke element rests against the corresponding secondary leg element, and a radially outermost contact point at which again the corresponding yoke element rests against the corresponding leg element.

In a further embodiment of the invention the primary leg elements and/or the secondary leg elements each consist of a laminated core which rests against the primary yoke element or the secondary yoke element along the joint edge. Insofar not only the primary yoke element or the secondary yoke element consist of a laminated core. Rather it is provided that primary leg elements are assigned to the primary yoke element, which consists of the laminated core, which primary leg elements are each also made of a laminated core. In addition or as an alternative secondary leg elements are assigned to the secondary yoke element, which is made of the laminated core, which secondary leg elements are also made of such a laminated core. As explained above, joint edges are present between the primary leg elements and the primary yoke element or between the secondary leg elements and the secondary yoke element at which a respective primary leg element or secondary leg element rests against the primary yoke element or the secondary yoke element.

In a preferred embodiment of the invention it can be provided that the laminated core of the primary yoke element and/or the secondary yoke element is made of multiple laminated core parts, which respectively rest against one of multiple laminated core parts of the laminated core of one of the primary leg elements or the secondary leg elements. The laminated core parts can hereby have exactly one lamination or multiple laminations. When the laminated core part is made of multiple laminations it can also be referred to as lamination packet. The multiple laminated core parts of which the laminated core is composed preferably have different dimensions relative to each other, in particular in longitudinal section relative to the rotation axis. In particular immediately adjacent laminated core parts have different dimensions for example in axial direction. Due to the different dimensions of the multiple laminated core parts the slant of the joint edge can be realized.

In the case of the primary yoke element and/or the secondary yoke element the individual laminations of the laminated core can be arranged directly adjacent each other in radial direction. The dimensions of the laminations are greatest in axial direction and in circumferential direction while their thickness in radial direction is smaller than the dimensions in axial direction and in circumferential direction. In the case of the primary leg elements and/or the secondary leg elements the laminated core can have laminations that are arranged adjacent each other in axial direction. Their dimensions in axial direction are insofar smaller than their dimensions in circumferential direction and in radial direction.

A refinement of the invention provides that—when viewed in longitudinal section—the joint edge extends continuously straight or stepped. The straight extent of the joint edge is for example realized by the configuration of a chamfer on the primary yoke element or the secondary yoke element and primary leg element or the secondary leg element, which rests against the primary yoke element or the secondary yoke element along the joint edge. In such a configuration the joint edge coincides along its entire extent with a straight line or its longitudinal center axis. As an alternative the joint edge can also extend stepped, i.e., it can have a discrete course. The stepped configuration is preferably uniform so that the longitudinal center axis of the stepped joint edge is straight or coincides with a straight line. As mentioned above, when viewed in longitudinal section, the longitudinal center axis of the joint edge preferably corresponds to an imagined connection between a radially innermost contact point and a radially outermost contact point. There between the longitudinal center axis can generally have any course, preferably however it is straight which is in particular realized by the uniform stepped configuration of the joint edge.

In a preferred embodiment of the invention the primary yoke element and/or the secondary yoke element are curved in circumferential direction, in particular have a constant radius in circumferential direction in relation to the rotation axis. Particularly preferably the primary yoke element and/or the secondary yoke element completely engage about the rotation axis in circumferential direction or at least to the most part, for example at least 75%, at least 80%, at least 85%, at least 90% or at least 95%. The curvature of the primary yoke element and/or the secondary yoke element can generally be configured arbitrary. Preferably however the curvature is constant in circumferential direction, resulting in the constant radius.

Usually the primary yoke element assigned to the stator is arranged in radial direction further outwardly than the secondary yoke element assigned to the rotor. Correspondingly the primary yoke element preferably has a greater radius than the secondary yoke element. As an alternative of course also an opposite configuration can be realized in which the primary yoke element is arranged inwardly in radial direction and the secondary yoke element is arranged outwardly in radial direction.

According to another advantageous feature of the invention, the primary yoke leg elements and/or the secondary leg elements is/are circular. The primary leg elements are arranged spaced apart in axial direction in particular on opposite sides of the primary yoke element. The same applies to the secondary leg elements and their arrangement relative to the secondary yoke element. For example the primary leg elements end flush on one side with the primary yoke element. This can be provided in addition or as an alternative for the secondary leg elements regarding the secondary yoke element. Hereby the primary leg elements and/or the secondary leg elements are preferably circular, i.e., —when viewed in cross section relative to the rotation axis—have a central recess.

According to another advantageous feature of the invention, the primary leg elements and/or the secondary leg elements have at least one radial slot and/or a comb structure, which traverses in radial direction. The term radial slot means a slot which extends in radial direction and which completely traverses at least one of the primary leg elements and/or the secondary leg elements in radial direction. Additionally it can be provided that the radial slot traverses this at least one leg element also in axial direction. At the position of the radial slot the respective leg element is thus interrupted in circumferential direction.

In addition or as an alternative at least one of the primary leg elements and/or the secondary leg elements can have the comb structure. The comb structure is formed on a side of the primary leg elements that faces away from the primary yoke element or the side of the secondary leg elements, which faces away from the secondary yoke element. The comb structure has a plurality of slots spaced apart in circumferential direction, which completely traverse the respective leg element in axial direction. The slots preferably extend in radial direction, and hereby traverse the respective leg element in this direction however only partially.

By means of the radial slot and/or the comb structure eddy currents can be effectively prevented. When the primary leg element or the secondary leg element is made of a laminated core, which has multiple laminated core parts, each laminated core part can have such a radial slot. The laminated core parts are arranged relative to each other so that the radial slots of the plurality of laminated core parts are offset in radial direction relative to each other. In this way a particularly high mechanical strength of the primary leg elements or the secondary leg elements is realized.

According to another advantageous feature of the invention, the primary winding and/or the secondary winding can have a flat ribbon conductor or a flat ribbon cable. The flat ribbon conductor or flat ribbon cable preferably have a width, which corresponds to the distance between the primary leg elements or the secondary leg elements. The width of the flat ribbon conductor or flat ribbon cable relative to the distance between the primary leg elements or the secondary leg elements is however at least 75%, at least 80%, at least 85%, at least 90% or at least 95%. The flat ribbon conductor has for example a metal layer, which extends over the entire width of the flat ribbon conductor. For example the metal layer is applied onto a carrier layer, for example made of polyester or the like. The flat ribbon cable can also be referred to as “Flat Flex Cable (FFC). The flat ribbon cable is a multi-vein cable, wherein the multiple veins are arranged adjacent each other or parallel to each other.

According to another advantageous feature of the invention, a plate can be arranged on a front face of the secondary coil device, which plate has a rectifier circuit which is connected to the secondary winding. The secondary coil device thus serves as a carrier for the plate. The plate is for example fastened on at least one of the secondary leg elements. The rectifier circuit serves for rectifying the electric current provided by the secondary coil device. The rectifier circuit is insofar connected on one side to the secondary winding and on the other side to a further electric circuit, wherein the latter is for example an excitation winding of the electric machine. Usually the rectifier circuit is connected to both ends of the secondary winding. Hereby the secondary winding is guided out between the secondary leg elements, for example through one of the secondary leg elements. Hereby the secondary winding preferably extends through a radial slot and/or a slot of the comb structure.

According to another advantageous feature of the invention, components of the rectifier circuit are supported on the secondary coil device, in particular in radial direction. The plate on which the rectifier circuit is arranged is fastened on the secondary coil device. At least some of the components of the rectifier circuit are arranged on the side of the plate, which faces the secondary coil device. These components preferably engage at least partially in the secondary coil device so that they can be supported on the secondary coil device in particular in radial direction. For example the components are supported on the secondary yoke element. This ensures a high operational reliability also at higher rotational speeds of the energy transmission device and/or the electric machine.

According to another aspect of the invention An electric machine includes a stator; a rotor supported for rotation relative to the stator about a rotation axis; and an energy transmission device which includes a primary coil device and a secondary coil device, said secondary coil device being supported for rotation relative to the primary coil device about a rotation axis, said primary coil device having a primary yoke element, multiple primary leg elements and a primary winding, the secondary coil device having a secondary yoke element, multiple secondary leg elements and a secondary winding, the primary yoke element and/or the secondary yoke element being made of a laminated core, wherein, when viewed in longitudinal section relative to the rotation axis, the primary yoke element rests against at least one of the primary leg elements and/or the secondary yoke element rests against at least one of the secondary leg elements along a respective joint edge, wherein the respective joint edge and/or a longitudinal center axis of the respective joint edge being slanted relative to the rotation axis.

According to another advantageous feature of the invention, the electric machine can configured as electrically excited synchronous machine. Such a configuration was mentioned above.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a longitudinal sectional view through a region of an electric machine with an energy transmission device, and

FIG. 2 shows an exploded view of a region of a secondary coil device of the energy transmission device, which is assigned to a rotor of the electric machine.

### DETAILED DESCRIPTION OF PREFERRED EMBODIMENTS

Throughout all the Figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

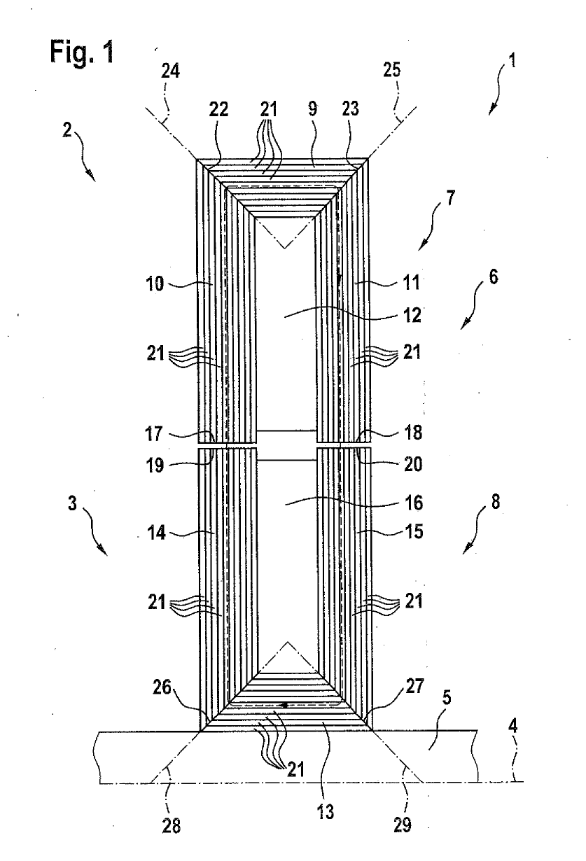

FIG. 1 shows a longitudinal section through a region of en electric machine 1 which has a stator 2 and a rotor 3. The rotor 3 is supported for rotation relative to the stator 2 about a rotation axis 4. The rotor 3 is arranged on a shaft 5 of the electric machine 1. The stator 2 and the rotor 3 are only shown partially. In particular an energy transmission device 6 can be seen which has a primary coil device 7 assigned to the stator 2 and a secondary coil device 8 assigned to the rotor 3. The primary coil device 7 has a primary yoke element 9, multiple primary leg elements 10 and 11 and a primary winding 12. The secondary coil device 8 on the other hand has a secondary yoke element 13, secondary leg elements 14 and 15 and a secondary winding 16. The primary leg elements 10 and 11 are hereby arranged on both sides on the primary yoke element 9, the secondary leg elements 14 and 15 on both sides on the secondary yoke element 13.

In the here shown longitudinal section the primary yoke element 9 and the secondary yoke element 13 extend parallel to the rotation axis 4, while the primary leg element 10 and 11 and the secondary leg elements 14 and 15 are perpendicular to the rotation axis 4. The primary leg elements 10 and 11 have free ends 17 and 18, the secondary leg elements 14 and 15 have free ends 19 and 20. The primary coil device 7 and the secondary coil device 8 are arranged so that the free ends 17 and 19 and the free ends 18 and 20 protrude toward each other and are respectively aligned with each other. The primary yoke element 9 forms a U-shaped arrangement with the primary leg elements 10 and 11. This is also the case for the secondary yoke element 13 with the secondary leg elements 14 and 15.

It can be seen that the primary yoke element 9 and the primary leg elements 10 and 11 are each made of a laminated core, wherein each laminated core is composed of a plurality of metal sheets 21 (only shown schematically). This is also analogously the case for the secondary yoke element 13 and the secondary leg elements 14 and 15. The primary leg element 10 rests against the primary yoke element 9 along a joint edge 22. Between the primary leg element 11 and the primary yoke element 9 a joint edge 23 is present. These joint edges 22 and 23 or longitudinal center axes 24 and 25 of the joint edges 22 and 23 are slanted relative to the rotation axis, i.e., they enclose an angle with the rotation axis when viewed in longitudinal section, which is greater than 0° and smaller than 90°. Particularly preferably the angle is 45°.

In analogy thereto joint edges 26 and 27 with longitudinal center axes 28 and 29 are present between the secondary yoke element 13 and the secondary leg elements 13 and 15. Also these are slanted relative to the rotation axis 4. The slant of the joint edges 22, 23, 26 and 27 in the present case is realized by the formation of chamfers at the primary yoke element 9, the primary leg elements 10 and 11, the secondary yoke element 13 and the secondary leg elements 14 and 15. Alternatively a stepped course of the joint edges 22, 23, 26 and 27 can be provided. The respectively neighboring elements rest against the joint edges 22, 23, 26 and 27 and are fastened to each other, for example by material bonding.

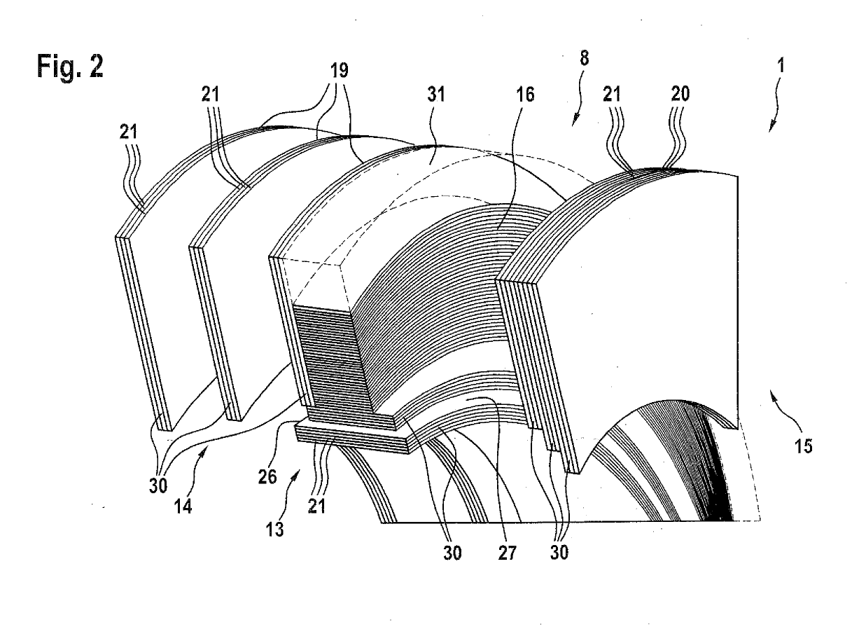

FIG. 2 shows an exploded view of a region of an electric machine 1, in particular a region of the secondary coil device 8. It can be seen that the secondary yoke element 13 is composed of multiple metal sheets 21. Also the secondary leg elements 14 and 15 each have multiple laminated core parts 30 which themselves are made of multiple laminations 21.

It can be seen that the laminated core parts 30 have different dimensions. In particular the laminated core parts 30 of the secondary yoke element 13 are configured so that they have different dimensions in axial direction, wherein the dimensions of the laminated core parts 30 in axial direction become shorter the greater the radial position relative to the rotation axis 4 is. The laminated core parts 30 of the secondary leg elements 14 and 15 on the other hand have dimensions in radial direction that are the greater the further the respective laminated core part 30 is removed from the secondary yoke element 13 in axial direction.

The free ends 19 and 20, which face away from the secondary yoke element 13 are aligned with each other. The dimensions of the laminated core parts 30 of the secondary yoke element 13 and the secondary leg elements 14 and 15 are selected so that a stepped course of the joint edges 26 and 27 results. This enables a comparatively simple production. Of course the primary yoke element 9 and the primary leg elements 10 and 11 can be configured analogously. In this case reference is made to the explanation above. It can further be seen that the secondary winding 16 is a flat ribbon cable and has dimensions in axial direction that correspond to the distance between the secondary leg elements 14 and 15 in axial direction. The secondary winding 16 can be covered with an insulating element 31.

The energy transmission device 6 described here in connection with the electric machine 1 can also be used separately. Correspondingly the features relating to the electric machine 1 itself are not necessarily required but are optional for the energy transmission device.

What is claimed as new and desired to be protected by Letters Patent is set forth in the appended claims and includes equivalents of the elements recited therein:

What is claimed is:

1. An energy transmission device for contactless transmission of electric energy, comprising:
a primary coil device and a secondary coil device, said secondary coil device being supported for rotation relative to the primary coil device about a rotation axis, said primary coil device having a primary yoke element, multiple primary leg elements and a primary winding, said secondary coil device having a secondary yoke element, multiple secondary leg elements and a secondary winding, said primary yoke element and/or said secondary yoke element being made of a laminated core, wherein, when viewed in longitudinal section relative to the rotation axis, the primary yoke element rests against at least one of the primary leg elements and/or the secondary yoke element rests against at least one of the secondary leg elements along a respective joint edge, said respective joint edge and/or a longitudinal center axis of the respective joint edge being slanted relative to the rotation axis.

2. The energy transmission device of claim 1, wherein the primary leg elements and/or the secondary leg elements are each made of a laminated core, which rests against the primary yoke element or the secondary yoke element along the respective joint edge.

3. The energy transmission device of claim 1, wherein when viewed in longitudinal section, the joint edge extends continuously straight or is stepped.

4. The energy transmission device of claim 1, wherein the primary yoke element and/or the secondary yoke element are curved in circumferential direction.

5. The energy transmission device of claim 4, wherein the primary yoke element and/or the secondary yoke element have a constant radius in circumferential direction relative to the rotation axis.

6. The energy transmission device of claim 1, wherein the primary leg elements and/or the secondary leg elements are circular.

7. The energy transmission device of claim 1, wherein the primary leg elements and/or the secondary leg elements have at least one radial slot and/or a comb structure, which traverses the primary leg elements or the secondary leg elements in radial direction.

8. The energy transmission device of claim 1, wherein the primary winding and/or the secondary winding have a flat ribbon conductor or a flat ribbon cable.

9. The energy transmission device of claim 1, further comprising a plate arranged on a front face of the secondary coil device, said plate having a rectifier circuit connected to the secondary winding.

10. The energy transmission device of claim 9, wherein components of the rectifier circuit are supported on the secondary coil device.

11. The energy transmission device of claim 10, wherein the components of the rectifier circuit are supported in the secondary yoke element and/or in radial direction.

12. An electric machine comprising:
a stator;
a rotor supported for rotation relative to the stator about a rotation axis; and
an energy transmission device comprising a primary coil device and a secondary coil device, said secondary coil device being supported for rotation relative to the primary coil device about a rotation axis, said primary coil device having a primary yoke element, multiple primary leg elements and a primary winding, said secondary coil device having a secondary yoke element, multiple secondary leg elements and a secondary winding, said primary yoke element and/or said secondary yoke element being made of a laminated core, wherein, when viewed in longitudinal section relative to the rotation axis, the primary yoke element rests against at least one of the primary leg elements and/or the secondary yoke element rests against at least one of the secondary leg elements along a respective joint edge, said respective joint edge and/or a longitudinal center axis of the respective joint edge being slanted relative to the rotation axis.
